(19) United States
(12) Patent Application Publication
(10) Pub. No.: US 2025/0328311 A1
(43) Pub. Date: Oct. 23, 2025

(54) SYSTEMS AND METHODS FOR ENERGY-EFFICIENT, BIT-PARALLEL, MULTIPLY-ACCUMULATE FOR ARTIFICIAL INTELLIGENCE AND DEEP NEURAL NETWORKS

(71) Applicants: Stefanos KAXIRAS, Uppsala (SE); Xiaoyue CHEN, Uppsala (SE); Yuan YAO, Stockholm (SE); Hannah E. ATMER, Uppsala (SE)

(72) Inventors: Stefanos KAXIRAS, Uppsala (SE); Xiaoyue CHEN, Uppsala (SE); Yuan YAO, Stockholm (SE); Hannah E. ATMER, Uppsala (SE)

(21) Appl. No.: 19/187,300

(22) Filed: Apr. 23, 2025

Related U.S. Application Data
(60) Provisional application No. 63/637,692, filed on Apr. 23, 2024.

(51) Int. Cl. G06F 7/483

(52) U.S. Cl. CPC G06F 7/483

(57) ABSTRACT

A system and method for providing a tunable floating-point multiply-accumulate (MAC) unit are disclosed. The unit maintains full arithmetic precision while enabling dynamic elimination of ineffectual computation through operand decomposition and selective activation of partial product generation logic. The disclosed MAC unit is suitable for drop-in replacement in existing deep-learning accelerators and improves energy efficiency without requiring architectural changes.

### CROSS-REFERENCE TO RELATED APPLICATION

The present application is related to, and claims priority from, U.S. Provisional Patent Application 63/637,692, filed Apr. 23, 2024, entitled “Systems and Methods for Energy-Efficient, Bit-Parallel, Multiply-Accumulate” to Stefanos Kaxiras et al., the entire disclosure of which is incorporated herein by reference.

### TECHNICAL FIELD

Embodiments described herein relate in general to computational circuits for deep learning accelerators, scientific computing, or other applications, particularly multiply-accumulate (MAC) units featuring tunable precision and energy efficiency.

### BACKGROUND

Accelerators for deep learning perform vast amounts of computation over vast amounts of data, especially for training. This leads to significant energy and power consumption per device (from a minimum of 100 W to 20 kW for wafer-scale integration). In recent years, the emphasis on optimizing for energy and power efficiency has primarily been placed on optimizing data movement. This led to the development of seminal approaches for reducing the cost of data movement. With increasing on-chip memory reaching today 100's of MiB, and increasing reuse of the on-chip data, the relative contribution of computation in energy and power consumption also increases.

In both training and inference, the fundamental compute operation is the Multiply-Accumulate (MAC), typically employed in dot-products. Due to the dominance of the dot-product in deep learning, a MAC operation naturally forms the basic floating point (FP) unit in AI accelerators. FIG. 1 illustrates a general block diagram of a MAC unit 100 for performing the operation X*Y+Z. Therein, the inputs to the multiplier 102 (X, Y) are each N-bit values, multiplied together and output as a multiplied value to adder 104. The multiplied value is added to Z by the adder 104, where Z is the output of accumulator/register 106.

Generally, MAC designs used in Deep Neural Network (DNN) acceleration fall into two categories: bit-parallel and bit-serial. Bit-parallel MAC designs often offer consistent precision, high performance, and are easy to reuse from design to design. They are preferred in most commercial and high-performance (ASIC or FPGA) designs. Typically, bit-parallel MACs either support the highest precision required by a network but are difficult to efficiently adjust to lower precisions (scale down), or, alternatively, support a lower precision but can be grouped for higher precision (scaled up), albeit at a steep performance cost. This is a problem since actual precision requirements vary considerably across different networks or even across the layers of the same network. Thus, bit-parallel MACs typically process more bits than needed, leading to inefficiency.

In contrast, bit-serial approaches offer the flexibility to adjust precision dynamically at runtime, making them particularly adept in exploiting ineffectual computation for energy-efficiency. While there are many bit-serial proposals for exploiting ineffectual integer computation (for inference), the state-of-the-art for floating point computation is the bit-serial FPRaker.

There are good reasons to consider bit-parallel designs, as bit-serial approaches bring their own set of constraints in an accelerator architecture: i) they are often multi-cycle designs with a value-dependent-latency which may necessitate extensive buffering to smooth out variability and synchronize communicating units, and ii) they often impose constraints on data movement as they must treat data as bit streams. While there are many promising proposals for bit-serial designs, they are not the implementation of choice for the leading high-performance commercial accelerators. On the other hand, bit-parallel designs have the potential to make immediate impacts on energy and power consumption as they can be integrated into existing accelerator architectures with minimum effort. The goal in this case would be to achieve lower energy at the same performance and area. This can be achieved, at least in part, by selectively discarding the least significant part of the mantissa as part of the MAC operation.

A well-known approach for discarding the least significant part of the mantissa computation is truncated multiplication. However, truncated multiplication is plagued by large errors that need to be corrected by adding a correction factor to the final result. To compute the correction factor, the bits that did not participate in the computation must be used. However, this erodes the potential benefit of truncated multiplication and makes it complex to adjust dynamically. Alternatively, a “buffer zone” of a few bit positions can be used to truncate the mantissa less than what is actually desired. Such a truncated multiplication approach is taken in FPRaker, which advocates exploiting term sparsity.

Accordingly, it would be desirable to design “one-shot” bit-parallel MACs (pipelined if needed), avoiding variable multi-cycle timing that complicates the macro-architecture (e.g., of a systolic array) by requiring interleaving and extensive buffering to absorb timing variations. In other words, the embodiments described below aim for a drop-in replacement of existing MAC units found in commercial designs.

### SUMMARY

Exemplary embodiments are directed to a tunable floating-point multiply-accumulate (MAC) unit. The unit maintains full arithmetic precision while enabling dynamic elimination of ineffectual computation through operand decomposition and selective activation of partial product generation logic. The disclosed MAC unit is suitable for drop-in replacement in existing deep-learning accelerators and improves energy efficiency without requiring architectural changes to the accelerators.

According to an embodiment, a floating-point multiply-accumulate (MAC) unit includes a multiplicative stage configured to compute partial products via a plurality of sub-multipliers; a control circuit operable to enable or disable one or more of the plurality of sub-multipliers; and an accumulation stage to aggregate outputs from enabled sub-multipliers with an additive operand.

According to an embodiment, floating-point multiply-accumulate (MAC) unit includes: a multiplicative stage that partitions each operand into two or more segments; a plurality of sub-multipliers to compute partial products based on segment pairs; a control logic configured to selectively enable or disable sub-multipliers based on exponent difference between the multiplicative result and an accumulator value; and an accumulation stage configured to aggregate the computed partial products with the accumulator value.

According to another embodiment, a method of performing multiply-accumulate operations, includes: partitioning input operands into segments; identifying ineffectual segments; computing partial products only for effective segments; and aggregating the computed partial products with an accumulator.

According to yet another embodiment, a method for performing multiply-accumulate operations, includes: associating each input operand segment with one of a plurality of sub-multipliers; enabling or disabling each of the plurality of sub-multipliers, wherein an enabled sub-multiplier generates a partial product based on its associated input operand segments; and aggregating the partial products generated by the enabled sub-multipliers with an addend to generate an output of the multiply-accumulate operation.

A method of operating a MAC unit with tunable precision includes: receiving floating-point operands; splitting the operands into at least three segments; computing a set of partial products using a corresponding set of sub-multipliers; determining an exponent difference between the multiplicative result and an addend; comparing the exponent difference to threshold values; and selectively disabling one or more sub-multipliers based on the threshold comparison.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is an illustration of a conventional multiply-accumulate (MAC) unit;

FIG. 2 is a block diagram of a MAC unit where the operands are split into two segments according to an embodiment;

FIGS. 3A-3D provide a visual depiction of the four possible ways of using an 11-bit multiplier according to the embodiment of FIG. 2 with a primary 3:8 split;

FIG. 4 provides a visual depiction of using an 11-bit multiplier with a primary 1:5:5 split according to an embodiment;

FIGS. 5A-5C illustrate operation of a MAC unit according to an embodiment for a 1:5:5 split in Full Mode, Skip-BD Mode, and AC Mode, respectively;

FIG. 6 shows a processing system in which MAC units according to the embodiments can be implemented; and

FIG. 7 is a flowchart showing a method according to an embodiment.

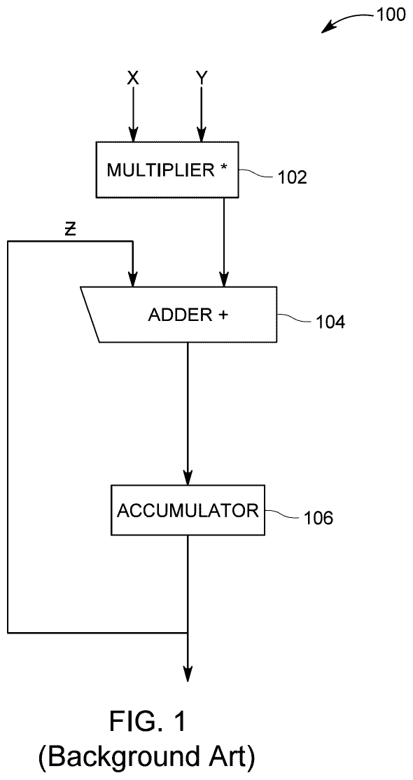

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to exemplary configurations. However, the embodiments to be discussed next are not limited to these configurations, but may be extended to other arrangements as discussed later.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification does not necessarily refer to the same embodiment. Further, the particular features, structures, or characteristics may be combined in any suitable manner in one or more embodiments.

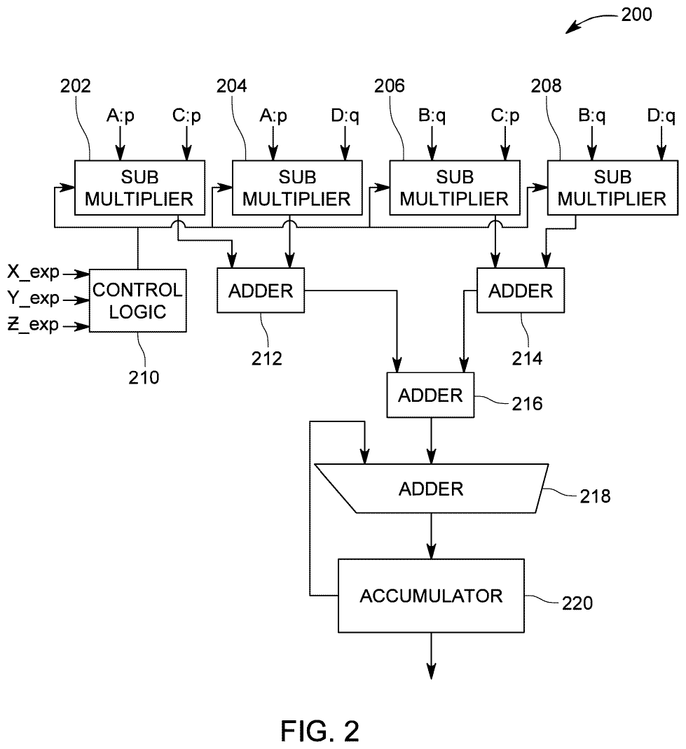

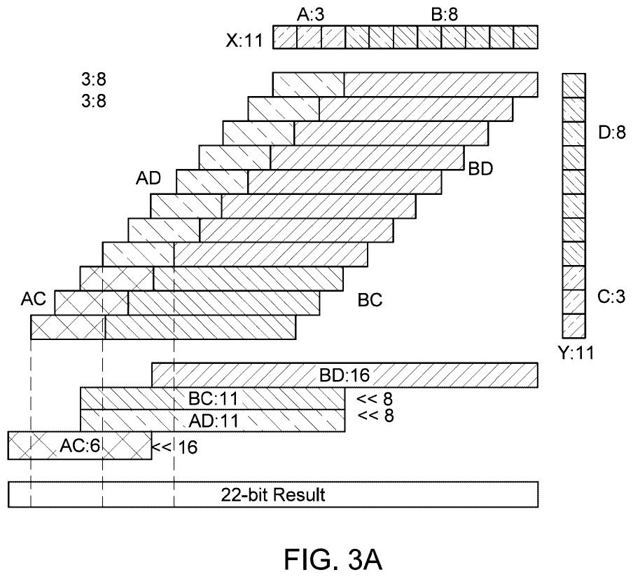

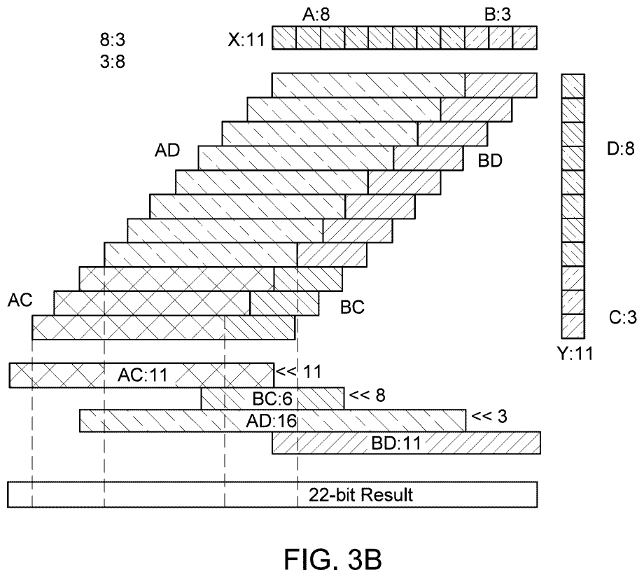

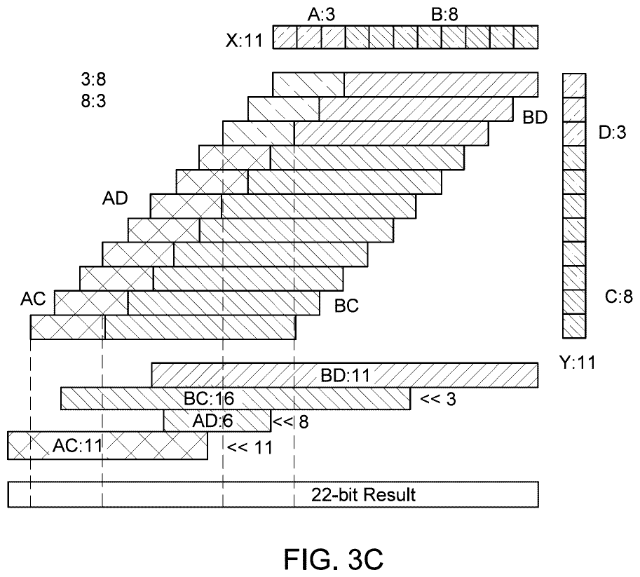

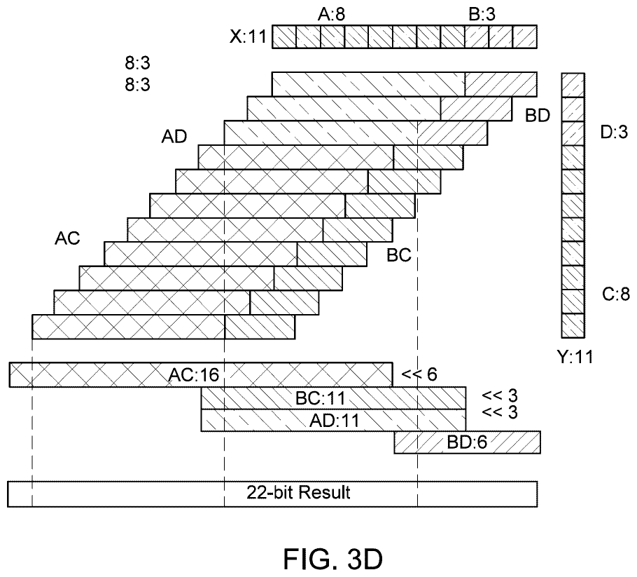

According to various embodiments, systems and methods are disclosed for a hardware unit 200 implementing a floating-point multiply-accumulate operation, defined as X·Y+Z, that is configured such that the multiplicative components are divided into multiple sub-components or segments (see below discussion of FIGS. 2-3D). In one embodiment, the multiplicative components (operands) are divided into two segments, and the multiplicative array is partitioned into four (4) independent sub-multipliers. It will be appreciated by those skilled in the art, that other embodiments may have more than two segments and more than four sub-multipliers, see discussion below. Each sub-multiplier is capable of computing partial products corresponding to portions of the input operands. Control logic determines which sub-multipliers (i.e., which partial product(s)) are necessary based on runtime analysis of the significance of operand segments. When a segment contributes negligibly to the final result, its corresponding sub-multiplier can be disabled, thereby reducing power consumption. In this context, disabling a sub-multiplier can include, for example, that the sub-multiplication hardware is physically input latched or clock gated, or power gated to reduce or disable power draw from inactive segments. This results in a disabled sub-multiplier outputting a value of zero for a particular calculation.

As will be appreciated by those skilled in the art, all floating-point representations are approximations of real numbers, and any operation that produces a result that does not fit in the representation introduces rounding error. The IEEE-754 floating-point standard requires any hardware implementation to produce a result with an error of no more than 0.5 Unit-in-Last-Place (ULP) when rounding to the nearest value (Round-To-Even or RTE), and less than 1 ULP when rounding up, down, or toward zero (Round-to-Zero, Round-to-Positive-Infinity, and Round-to-Negative-Infinity). The ULP of a real number x, when represented in a given floating point format, is the distance between the two closest floating point numbers a and b that surround x: a≤x≤b, a not equal to b, provided that the number x has a valid exponent in the representation (i.e., the exponent has not exceeded the maximum exponent of the representation). For example, the ULP for an IEEE-754 FP16 number whose exponent is e represents the value 2^{e-10}.

A “negligible contribution”, as that phrase is used herein, is a contribution that, if omitted, leads to an approximation ULP error, compared to the baseline (standard MAC) ULP error, that is tolerable to the application that is using the disclosed MAC unit. For example, AI applications may be tolerant of some approximation ULP error in the MAC units. The desired tolerance is communicated to the disclosed MAC unit through a set of user-tunable thresholds. “Negligible contributions” are generated by “ineffective segments” or “inactive segments”, whereas “significant contributions” (to the final result) are generated by “effective segments” or “active segments”.

For a given set of inputs X, Y, Z, the embodiments can produce a multitude of approximations of a multitude of ULP errors, depending on its configuration mode. As described below, the configuration mode is selected based on comparing the exponent difference, Z_exp−(X_exp+Y_exp), in the operation X·Y+Z, to a set of user-tunable thresholds. An existing adder, already present in standard MAC units to compute how much X·Y should be shifted to align with Z, can be used to calculate the exponent difference and configure the multiplier mode based on user-tunable thresholds.

After computing the exponent difference, that difference is compared to a set of user-tunable thresholds, and accordingly, zero, one, or more sub-multipliers are disabled.

In one embodiment, disabling a sub-multiplier is done by using latches to hold inputs and prevent gate switching in the corresponding sub-multiplier. In another embodiment, disabling a sub-multiplier is done by clock gating the sub-multiplier to prevent gate switching. In another embodiment, disabling a sub-multiplier is done by power gating the sub-multiplier to cut power to its gates.

The MAC unit, according to these embodiments, is compatible with systolic array architectures, such as those used in tensor processing units (TPUs) and graphics processing units (GPUs), and can be substituted for conventional MAC units without requiring modifications to the dataflow or scheduling logic of the hosting architecture. The techniques described herein differ from existing approaches that rely on static operand truncation by using, instead, operand splitting and runtime adaptivity to maintain precision and minimize computation. In hardware embodiments, this selective activation feature is achieved via gating logic embedded within the data path of the multiplier unit. The result is an adaptable MAC unit capable of reducing dynamic power usage during inference and training in deep neural networks.

FIG. 2 illustrates an example of a MAC unit 200 according to an embodiment having four independent sub-multipliers. In this embodiment, the two N-bit wide X and Y multiplication operands are each split into two parts of p-bit and q-bit widths (N=p+q) and input into sub-multipliers 202, 204, 206, and 208. The resulting (smaller) partial products output from sub-multipliers 202-208 are selectively assembled to yield the full result by controlling either their output from the sub-multipliers 202-208 or their input to the collective adders 212 or 214 using control logic 210. The control logic 210 receives the exponent values for X, Y, and Z as shown. These inputs are used by control logic 210 to determine which (if any) of the sub-multipliers 202-208 are disabled for this calculation. By omitting one or more of the partial products associated with one or more of the sub-multipliers, a lower energy consumption for the final (reduced-precision) result can be achieved. This aspect of MAC units, according to embodiments, will become more clear upon consideration of FIGS. 3A-3D described below. The outputs of collective adders 212 and 214 are provided to collective adder 216, and then to adder 218 in addition to a residual value Z from the accumulator 220 to generate the final output for this iteration from accumulator 220.

The manner in which the operands can be split into different bit-wise chunks for MAC operation can enable embodiments to more granularly select an appropriate tradeoff between power conservation and accuracy of the final result as will now be described beginning with the embodiment of FIG. 2 and continuing with the graphical representations of different configurations in FIGS. 3A-3D. Therein, MAC unit 200 performs the MAC unit multiplication, X·Y, where X and Y are N-bits wide, as follows. X:N is split into two parts of p and q bits (N=p+q), respectively: A:p and B:q; similarly, Y:N is split into C:p and D:q.

X and Y and their product are now expressed as:

$$X = A \cdot {2}^{q} + B \qquad ( 1 )$$

$$Y = C \cdot {2}^{q} + D \qquad ( 2 )$$

$$XY = AC \cdot {2}^{{2}_{q}} + AD \cdot {2}^{q} + BC \cdot {2}^{q} + BD \qquad ( 3 )$$

Using the IEEE FP16 mantissa multiplication as an example, N=11 (10 bits plus an implied “1”). For a 3:8 split, when the {X,Y} operands are split {3:8, 3:8}, the embodiment of FIG. 2 computes X·Y as:

$$X \cdot Y = AC \cdot {2}^{16} + AD \cdot {2}^{8} + BC \cdot {2}^{8} + BD \qquad ( 4 )$$

where the multiplications with power-of-two correspond to an alignment of the partial product with respect to the resulting 22-bit mantissa. Equation (4) shows one possible configuration for a primary 3:8 split MAC embodiment. Table 1 below shows all four possible configurations for a primary 3:8 split MAC embodiment for an 11-bit IEEE FP16 (or TF32) mantissa. In the two middle rows, X and Y are split in the same way, while in the top and bottom rows, X and Y are mirror-split.

TABLE 1

| X | Y | XY product |
|---|---|---|
| A:p, B:q | C:p, D:q | AC · 2^{2q} + AD · 2^{q} + BC · 2^{q} + BD |
| A:q, B:p | C:p, D:q | AC · 2^{p+q} + AD · 2^{p} + BC · 2^{q} + BD |
| A:p, B:q | C:q, D:p | AC · 2^{p[+q} + AD · 2^{q} + BC · 2^{p} + BD |
| A:q, B:p | C:q, D:p | AC · 2^{2p} + AD · 2^{p} + BC · 2^{p} + BD |

It can be seen from Table 1, that each of the different possible configurations requires the same four partial products (i.e., AC, AD, BC, and BD), which correspond to the sub-multipliers 202, 204, 206, and 208, respectively. As will be described in more detail below any of the sub-multipliers 202-208 can be disabled to save power by control logic 210 when one or more operating conditions are met, an example of which is provided below.

FIGS. 3A-3D provide a visual depiction of the four possible ways of using an 11-bit multiplier according to the embodiment of FIG. 2 with a primary 3:8 (p=3b and q=8b) split. The four cases correspond to the four ways of splitting the operands as shown in the four rows of Table 1. An important insight (depicted in FIGS. 3A-3D) regarding this design is its property of vertical and horizontal mirror symmetry, which endows the design with the flexibility to generate four different sets of partial products in the same hardware. A significant characteristic of these embodiments is that, regardless of how each of the X and Y operands is split into two parts of p and q bits, the required hardware is always the same. In this example, the same four hardware sub-multipliers 202-208 are involved: a p by p, two p by q, and a q by q (a 3b by 3b, two 8b by 3b, and an 8b by 8b for the p=3b and q=8b example of FIG. 2) regardless of which configuration in Table 1 is used. That feature enables embodiments to modulate precision versus energy consumption (by selectively omitting some of the partial products as described below) in four different ways as discussed below.

There are five possible primary two-way p:q splits (1:10, 2:9, 3:8, 4:7, 5:6), for an 11-bit mantissa, each of which can be used in four configurations (e.g., as shown in FIGS. 3A-3D). For a given p:q split, each of its four configurations can be used in four different modes to trade precision versus energy consumption. While the embodiment of FIG. 2 splits the input operands each in two ways, the design space for trading off between precision and energy consumption becomes significantly larger if the input operands are split in more than two ways.

For example, consider splitting an 11-bit operand in three ways, e.g., a 1:5:5 split, according to another embodiment. With more than a two-way split, partial products having a finer granularity are produced, but also more hardware is needed for routing and aligning these partial products for their addition. For an operand width of N=r+p+q, let:

$$X = {A}^{′} \cdot {2}^{p + q} + A \cdot {2}^{q} + B \qquad ( 5 )$$

$$Y = {C}^{′} \cdot {2}^{p + q} + C \cdot {2}^{q} + D \qquad ( 6 )$$

$$then$$

$$XY = {A}^{′} {C}^{′} \cdot {2}^{2 ( p + q )} + {A}^{′} C \cdot {2}^{p + 2 q} + {A}^{′} D \cdot {2}^{p + q} + {AC}^{′} \cdot {2}^{p + 2 q} + AC \cdot {2}^{2 q} + AD \cdot {2}^{q} + {BC}^{′} \cdot {2}^{p + q} + BC \cdot {2}^{q} + BD \qquad ( 7 )$$

which corresponds to nine partial products and eight additions. While this may seem excessive, there is a particularly efficient three-way split that simplifies Equation (7): the 1:p:q split (r=1). In this split, A′ and C′ correspond to the most significant—implied—bits of the respective mantissas.

For a normal FP number, the leading bit of its mantissa is implicit and is necessarily 1. Prepending a leading 1 to X and Y, denoted as X′ and Y′ respectively, yields the following equations:

$${X}^{′} = {2}^{p + q} + A \cdot {2}^{q} + B \qquad ( 8 )$$

$${Y}^{′} = {2}^{p + q} + C \cdot {2}^{q} + D \qquad ( 9 )$$

$${X}^{′} {Y}^{′} = {2}^{2 ( p + q )} + ( X + Y ) \cdot {2}^{p + q} + AC \cdot {2}^{2 q} + AD \cdot {2}^{q} + BC \cdot {2}^{q} + BD \qquad ( 10 )$$

The first line of Equation (10) contains only additions, and the second line is the same as Equation (3). The second line of Equation (10) is a two-way p:q split of a (p+q) bit·(p+q) bit multiplication. When multiplying denormal mantissas, A′=0 and/or C′=0, the corresponding X or Y terms and the constant term disappear.

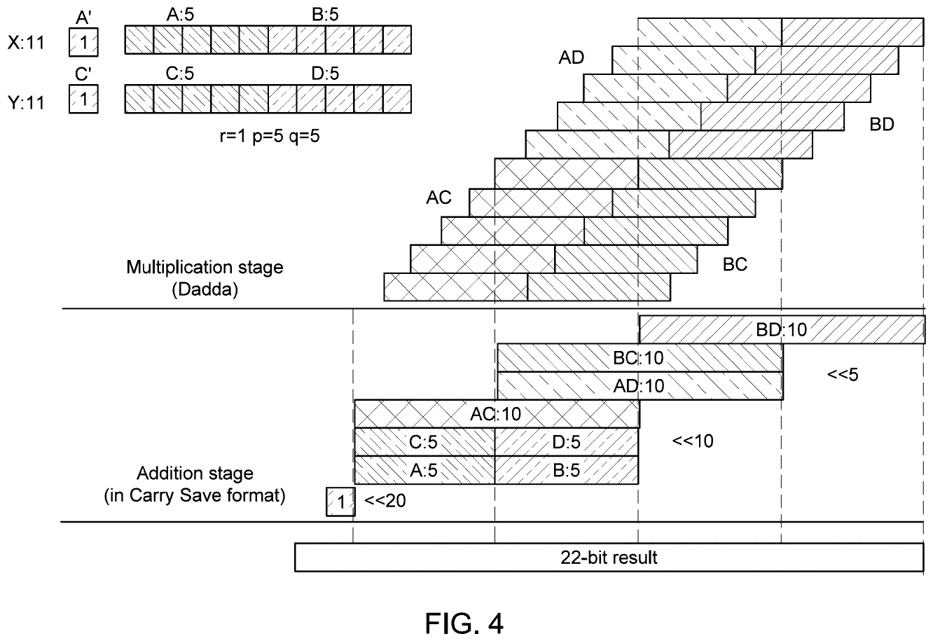

Thus, a 1:p:q split reduces the multiplication size by one bit in both operands: for the 11-bit FP16 mantissas this embodiment only needs to perform a 10×10 multiplication. Furthermore, by picking p=q=5 (i.e., a 1:5:5 split), a symmetrical design is obtained, which is shown in FIG. 4 and described by Equation (11) as:

$$XY = {2}^{20} + X \cdot {2}^{10} + Y \cdot {2}^{10} + AC \cdot {2}^{10} + AD \cdot {2}^{5} + BC \cdot {2}^{5} + BD \qquad ( 11 )$$

This three-way, 1:5:5, split has the following properties: (1) due to symmetry, all of four spatial configurations (FIGS. 3A-3D) of a 5:5 split are identical (see FIG. 4); (2) there is only one type of multiplier, a 5 bit×5 bit multiplier resulting in a consistent latency for the partial products; (3) four 5 bit×5 bit multipliers are used in parallel, which have a significantly smaller latency than an 11 bit×11 bit multiplier allowing room to hide the latency of the additions of the partial products (in this embodiment the partial products are in Carry-Save format); and (4) all the partial products are of the same width, 10 bits, and their alignment for the addition to produce the final product is static (no multiplexers are needed as in the case of the four different spatial configurations). The single bit that corresponds to the “1” in the three-way 1:5:5 split, is the hidden mantissa bit and always has the value of one (for normal floating-point values; it has the value of zero for sub-normal or de-normal floating-point values) and does not participate in the configuration of the rest of the MAC unit. From a configuration perspective, the 1:5:5 split is the same as any other two-way split. In the general case of a three-way p:q:r split where p is more than one (the corresponding field contains more bits than the hidden mantissa bit), the disclosed MAC has nine sub-multipliers (in a 3×3 grid, instead of a 2×2 grid for a two-way split) and the configuration modes, threshold values, and configuration conditions, become correspondingly more numerous. Further splits, for example, four-way 1:p:q:r or four-way p:q:r:s splits, are a generalization of the same operating principle. For large floating point formats, for example, 32-bit or 64-bit formats, N-way splits, where N>2, are a particularly good fit, resulting in a multitude of configuration options and a wide trade-off between approximation accuracy and energy efficiency.

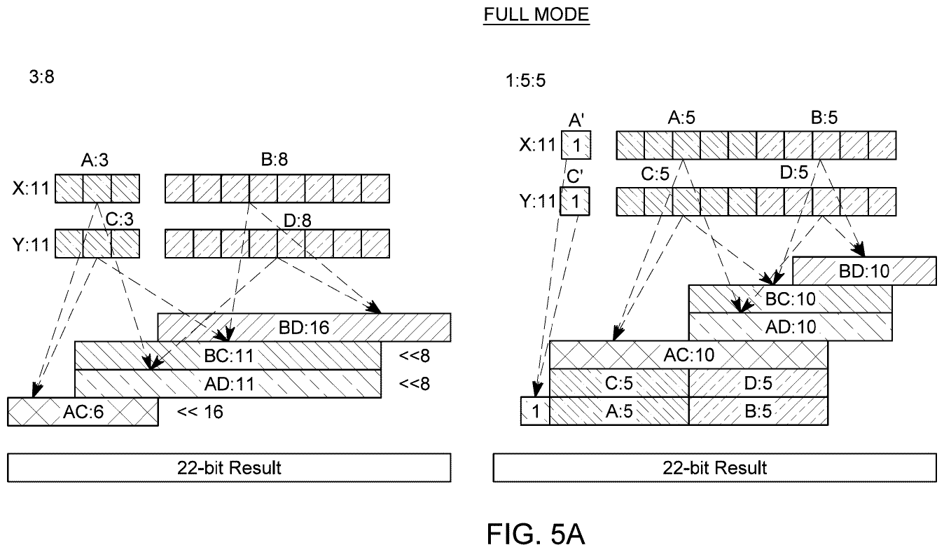

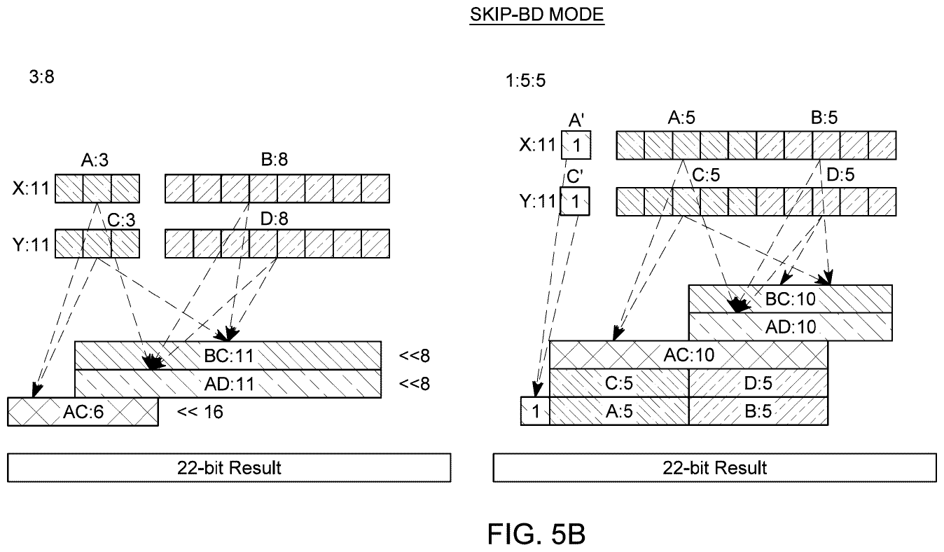

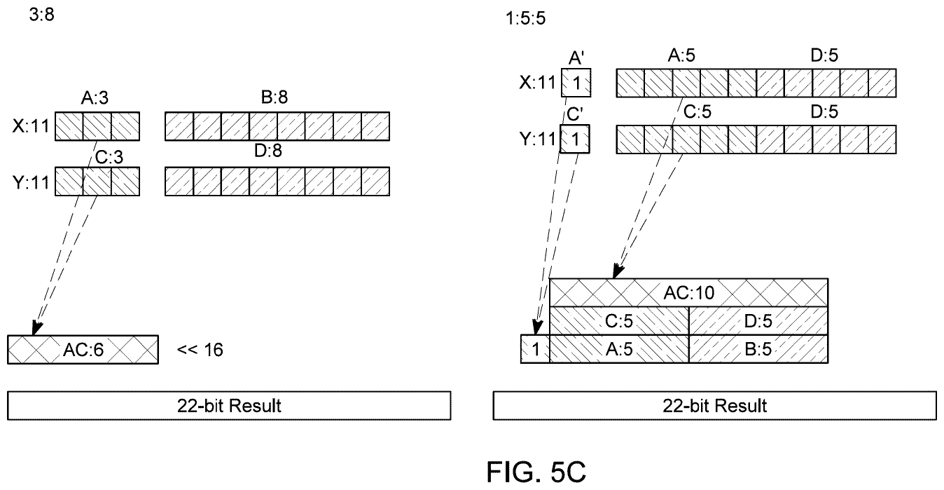

One advantage of these embodiments over a monolithic multiplier is that the precision of the result versus energy consumption is modulated by enabling or disabling individual parts of the multiplier. There are at least six modes of operation, three of which are shown in FIGS. 5A-5C for a 3:8 split on the lefthand side and a 1:5:5 split on the righthand side, respectively:
Full Mode: In full mode, all the partial products are considered to produce a precise FP16 result (see FIG. 5A);
Skip-BD Mode: In this mode, the tail partial product, BD, responsible for the low-order bits of the result is skipped (see FIG. 5B). This can lead to some energy savings while preserving accuracy in the high-order result bits;
AC-BC Mode: By keeping the head partial product AC and BC, some high-order bit accuracy is maintained while saving more energy than Skip-BD (not shown in FIGS. 5A-5C);
AC-AD Mode: By keeping the head partial product AC and AD, some high-order bit accuracy is maintained while saving more energy than Skip-BD (not shown in FIGS. 5A-5C);
AC Mode: By keeping the head partial product, AC, some high-order bit accuracy is maintained while saving the most energy compared to the previous modes (see FIG. 5C); and
Null Mode: The Null Mode can be used according to some embodiments in two situations: (a) when at least one of the operands of the multiplication is zero; and (b) when the alignment shift s is greater than the mantissa width: s>11 (for IEEE FP16). Null Mode discards both the multiplication and the addition.

In one embodiment, A and C are rounded representations of the full {A·B} and {C·D}, respectively.

In one embodiment the required precision of the multiplication is determined by considering the exponents of the multiplier, the multiplicand, and the addend. The exponents are used to determine the configuration of the multiplier for energy savings while delivering the needed precision.

In one embodiment, if the exponent difference between the product XY and the accumulator Z is s=e_{z}−(eₓ+e_{y}), then the mode can be selected based upon the s value as shown in Table 2 below:

TABLE 2

| Threshold | Mode Selected |
|---|---|
| s ≤ 0 | Full Mode |
| s ε 1 . . . threshold −1 | Skip-BD Mode |
| s ε threshold . . . 11 | AC Mode |
| s > 11 | Null Mode |

Once a MAC unit, according to these embodiments, is designed with a specific split, the error bounds for its various modes are fixed (from the full precision of the Full Mode to the reduced precision of the AC Mode). The disclosed MAC unit is flexible because its behavior can be tuned by setting the thresholds where the MAC unit changes from one mode to the next, according to the run-time exponent difference of MAC operations. The thresholds are given as parameters to the hardware and could potentially be changed during run-time. The threshold values, for example, the values of Table 2, are provided by the user and are stored in shared registers, which are shared by a multitude of MAC units, or local registers within a MAC unit. The user writes values in these registers to change the mode configuration behavior of the MAC unit(s).

The thresholds define the guaranteed error bound and, therefore, the numerical stability of a MAC unit according to these embodiments can be controlled. The thresholds can be changed more aggressively for more power savings at the expense of increased error, depending on how insensitive the target application is to error.

The disclosed embodiments provide a novel bit-parallel approach for energy-efficient MACs. The novelty of MAC units described in accordance with these embodiments includes, but is not limited to, the feature that it disassembles the multiplication into multiple smaller multiplications, which it (selectively) reassembles to create the final result. An important insight associated with these embodiments is that, due to the properties of multiplication, this takes approximately the same hardware as the baseline MAC.

These embodiments exploit the distribution of exponent differences in MACs to dynamically enable or disable parts of a MAC unit multiplier to yield the desired precision for the product. The embodiments provide a drop-in replacement for a standard MAC as it guarantees: i) full precision (indistinguishable from the baseline standard MAC)—something that other approximate approaches, in general, fail to do, ii) same or lower area, iii) same or lower latency, iv) same or lower power. When the embodiments are used in their Full Mode, they behave identically to a standard MAC in terms of error, performance, area, latency, and energy or power. When the embodiments are used in one of their lower-power modes, they deliver a reduced-precision result (but always within well-established error bounds that are close to the standard) at the same performance but with lower energy consumption. Thus, the afore-described embodiments provide a family of possible designs for the multiplier, depending on the chosen split of the operands.

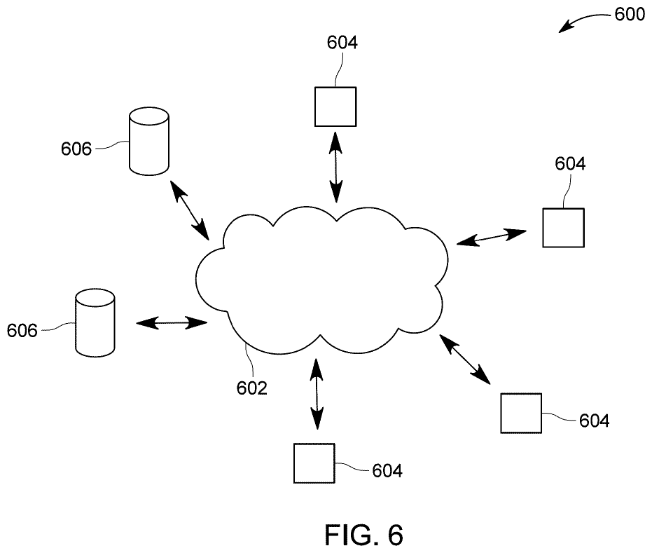

Referring now to FIG. 6, exemplary embodiments are directed to MAC units capable of selectable modes which provide tradeoffs between precision of the multiplication result versus power consumption, which are particularly useful in processing systems such as DNN systems and GPUs. The processing system 600 includes one or more memories or storage medium 606. Suitable memories and storage mediums are known and available in the art. These storage mediums include one or more databases that store the operating system instructions and computer programs that provide the processor instructions that are executed on the processing system 600. The processing system also includes one or more processors 604 to execute processor instructions from a computer program executing on the processing system. Any suitable processor known and available in the art can be used, including central processor units (CPU), servers, and computers. The memories and processors can be in communication across one or more local or wide area networks 602. The processing system 600 can be arranged as a standalone processing system or as a distributed or cloud-based processing system. In one embodiment, the processing system 600, including the processors 604, includes other hardware, software, and firmware utilized for the functioning of the processing system, including communication and networking components. In one embodiment, the processors can include memories systems including cache memory that provides for the registers, queues, databases, bloom filters, registers and buffers utilized by the methods discussed herein.

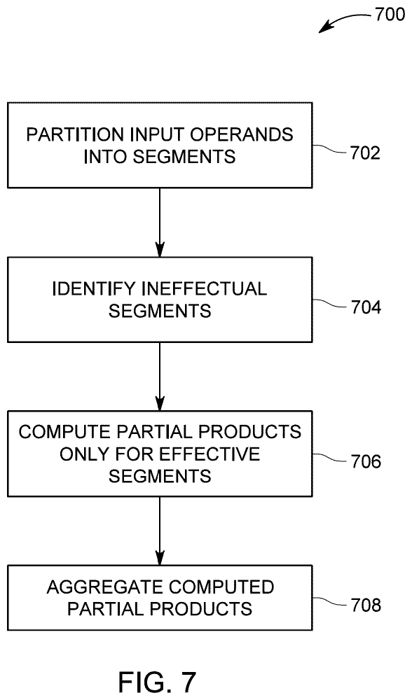

Embodiments described above have been characterized and illustrated as MAC units having hardware and associated logic signals. However, the embodiments can also be characterized as methods for performing multiply-accumulate operations, e.g., as shown in the method 700 of the flowchart of FIG. 7. Therein, at step 702, the input operands are partitioned into a plurality of segments, e.g., two, three, or more. The ineffectual segments are then identified at step 704, i.e., those segments whose partial product negligibly affect the value of the final product as compared to the energy that could be saved by disabling those segments. Accordingly, at step 706, partial products are instead only computed for other segments than those identified in step 704, i.e., “effective” segments. The resulting partial products continue through the multiplication stage(s) until a single multiplication product is generated, at which time the single multiplication product is aggregated with the accumulator value, i.e., to aggregate the computed partial products at step 708.

Methods and systems in accordance with exemplary embodiments of the present invention can take the form of an entirely hardware embodiment, an entirely software embodiment, or an embodiment containing both hardware and software elements. In one embodiment, the invention is implemented in software, which includes but is not limited to firmware, resident software and microcode. In addition, exemplary methods and systems can take the form of a computer program product accessible from a computer-usable or computer-readable storage medium including a non-transient computer-readable storage medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which temporarily store at least some program code to reduce the number of times code must be retrieved from bulk storage during execution. Input/output or I/O devices, including but not limited to keyboards, displays, and pointing devices, can be coupled to the system either directly or through intervening I/O controllers. Exemplary embodiments of the methods and systems per the present invention also include network adapters coupled to the system to enable the data processing system to become coupled to other data processing systems, remote printers, or storage devices through intervening private or public networks. Suitable currently available network adapters include, but are not limited to, modems, cable modems, DSL modems, Ethernet cards, and combinations thereof.

In one embodiment, the present invention is directed to a machine-readable or computer-readable medium containing a machine-executable or computer-executable code that when read by a machine or computer causes the machine or computer to perform a method for dynamic elimination of ineffectual computation through operand decomposition and selective activation of partial product generation in a processing system and to the computer-executable code itself. The machine-readable or computer-readable code can be any type of code or language capable of being read and executed by the machine or computer and can be expressed in any suitable language or syntax known and available in the art, including machine languages, assembler languages, higher-level languages, object-oriented languages, and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

It should be understood that this description is not intended to limit the invention. On the contrary, the exemplary embodiments are intended to cover alternatives, modifications and equivalents, which are included in the spirit and scope of the invention. Further, in the detailed description of the exemplary embodiments, numerous specific details are set forth in order to provide a comprehensive understanding of the invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A floating-point multiply-accumulate (MAC) unit comprising:
a multiplicative stage configured to compute partial products via a plurality of sub-multipliers;
a control circuit operable to enable or disable one or more of the plurality of sub-multipliers; and
an accumulation stage to aggregate outputs from enabled sub-multipliers with an additive operand.

2. The MAC unit of claim 1, wherein the sub-multipliers are at least four in number and each corresponds to a portion of the input operand bit-width.

3. The MAC unit of claim 1, wherein the control circuit detects operand significance by evaluating exponents of the operands to determine whether to disable or enable said one or more of the plurality of sub-multipliers.

4. A floating-point multiply-accumulate (MAC) unit comprising:
a multiplicative stage that partitions each operand into two or more segments;
a plurality of sub-multipliers to compute partial products based on segment pairs;
a control logic configured to selectively enable or disable sub-multipliers based on exponent difference between the multiplicative result and an accumulator value; and
an accumulation stage configured to aggregate the computed partial products with the accumulator value.

5. A MAC unit as in claim 4, wherein the multiplicative stage implements a 1:p:q operand split for mantissas that include a hidden bit and utilizes four sub-multipliers for partial product computation for the pairs of the p and q segments of the operands.

6. The MAC unit of claim 5, wherein the partial products are statically aligned using fixed shifts based on segment position to eliminate dynamic alignment logic.

7. The MAC unit of claim 4, wherein the control logic compares an exponent difference, s=ez−(ex+ey), to user-configurable thresholds to determine an operational mode.

8. The MAC unit of claim 7, wherein the operational mode is selected from a group of modes consisting of at least a Full Mode, a Null Mode, and one or more modes where each mode represents a collection of enabled or disabled sub-multipliers.

9. The MAC unit of claim 7, wherein the thresholds are stored in configuration registers and are settable at runtime by software or firmware instructions.

10. The MAC unit of claim 4, wherein sub-multipliers are disabled by one or more of: input latching, clock gating, or power gating.

11. A method of performing multiply-accumulate operations, comprising:
partitioning input operands into segments;
identifying ineffectual segments;
computing partial products only for effective segments; and
aggregating the computed partial products with an accumulator.

12. The method of claim 11, wherein identifying ineffectual segments comprises thresholding a function of the exponent values or significance heuristics.

13. The method of claim 11, wherein the multiplication hardware is physically input latched or clock gated, or power gated to reduce or disable power draw from inactive segments.

14. A method for performing multiply-accumulate operations, comprising:
associating each input operand segment with one of a plurality of sub-multipliers;
enabling or disabling each of the plurality of sub-multipliers, wherein an enabled sub-multiplier generates a partial product based on its associated input operand segments; and
aggregating the partial products generated by the enabled sub-multipliers with an addend to generate an output of the multiply-accumulate operation.

15. The method of claim 14, wherein the step of enabling or disabling further comprises:
detecting operand significance by evaluating exponents of the input operands to determine whether to disable or enable said one or more of the plurality of sub-multipliers.

16. The method of claim 14, wherein the step of enabling or disabling further comprises:
enabling all of the plurality of sub-multipliers to generate a full precision version of the output.

17. The method of claim 14, wherein the step of enabling or disabling further comprises:
disabling at least one of the plurality of sub-multipliers to generate a less than full precision version of the output while reducing energy usage associated with the multiply-accumulate operation.

18. A method of operating a MAC unit with tunable precision comprising:
receiving floating-point operands;
splitting the operands into at least two segments;
computing a set of partial products using a corresponding set of sub-multipliers;
determining an exponent difference between the multiplicative result and an addend;
comparing the exponent difference to threshold values; and
selectively disabling one or more sub-multipliers based on the threshold comparison.

19. The method of claim 18, further comprising configuring the MAC unit into one of a plurality of modes to balance precision and power consumption.
